(19) United States
(12) Patent Application Publication
(10) Pub. No.: US 2016/0180320 A1
(43) Pub. Date: Jun. 23, 2016

(54) SYSTEM AND METHOD FOR FACILITATING AN ONLINE TRANSACTION WITH A SECOND MOBILE DEVICE

(71) Applicant: APRIVA, LLC, Scottsdale, AZ (US)

(72) Inventors: Michael S. Klingen, Paradise Valley, AZ (US); Rinaldo A. Spinella, Medford, MA (US)

(73) Assignee: APRIVA, LLC, Scottsdale, AZ (US)

(21) Appl. No.: 14/580,084

(22) Filed: Dec. 22, 2014

(51) Int. Cl. G06Q 20/32; G06Q 20/42; G06Q 20/02; H04L 29/08

(52) U.S. Cl. CPC G06Q 20/322; H04L 67/10; G06Q 20/42; G06Q 20/027

(57) ABSTRACT

In a purchase transaction, a shopping mobile customer device operated by a shopping customer sends transaction information to a payment gateway and sends a beacon signal containing a transaction identifier to a paying mobile customer device operated by a paying customer who may be the same or different from the shopping customer. The paying mobile customer device sends the transaction identifier and payment information corresponding to a customer payment account to the payment gateway. The payment gateway applies the transaction identifier to access the transaction information and sends purchase information based on the transaction information to the paying mobile customer device which displays the purchase information to the paying customer, obtains an indication of assent to pay for the item and sends a confirmation of the assent to the payment gateway. Upon receiving the confirmation of assent, the payment gateway processes the purchase transaction based on the payment account information.

### FIELD OF THE INVENTION

The present invention relates generally to electronic payment transactions and, more particularly, to the utilization of mobile devices in such transactions.

### BACKGROUND

Users of mobile communication devices such as Smartphones can now employ their devices to make purchases. Such purchases may be made at a point of sale, in which case a wallet software application on the mobile device is invoked for selection and/or confirmation of payment using an account maintained by the wallet application. Purchases might also be made online using browser software on the mobile device to access and interact with a merchant web site. In some cases, however, the mobile device used to begin such a purchase may not be an appropriate or desirable means to pay for the purchase. For example, a mobile device used to select items for purchase over a merchant web site may not be equipped with a wallet application. As another example, even where the mobile device is equipped with a wallet application, the accounts it maintains may lack sufficient funds to cover the desired purchase.

For such reasons, it would be desirable to provide an alternative means of payment for a purchase initiated by a mobile communication device.

### SUMMARY OF THE INVENTION

The present invention provides, among other advantages that will be apparent to one of ordinary skill in the art from the description herein, a means of utilizing a second mobile device to facilitate a purchase transaction that is entered into using an online merchant application on a first mobile device. In one embodiment, the invention utilizes mobile devices that are both equipped with a means of short range communication between each other, such as a Bluetooth LE beacon signal. So equipped, the invention improves the effectiveness, security and/or efficiency of the transaction and/or simplifies the participation of a paying customer by providing immediate and direct communication of relevant data from the mobile device of a shopping customer to the mobile device of a paying customer. This allows, for example, the online merchant application to provide to the paying customer a means to uniquely identify the transaction to a payment gateway which can then process the payment.

The present invention may include, but is not necessarily limited to, the features and functions discussed in the following general description. When a shopping customer engages the online merchant application with one or more items for purchase, the online merchant application obtains a beacon payment selection from the shopping customer indicating that a beacon is to be utilized in performing the transaction. Correspondingly, the shopping customer device transmits to the paying customer device a beacon signal which contains a transaction identifier uniquely associated with the transaction. The online merchant application also sends to a payment gateway, over a mobile network used by the shopping customer device, transaction information based on the item information and a beacon payment indicator based on the beacon payment selection.

Upon the paying customer device receiving the beacon signal containing the transaction identifier, a wallet application on the paying customer device sends to the payment gateway, over a mobile network used by the paying customer device, the transaction identifier and payment account information corresponding to a payment account of the customer. The payment gateway uses the transaction identifier to identify the present transaction and access the transaction information that was provided by the merchant device, and then sends purchase information based on the transaction information to the paying customer device. The wallet application on the paying customer device displays the purchase information to the customer and obtains from the customer an indication of assent to pay for the items. Upon obtaining the indication of assent, the paying customer device sends to the payment gateway a confirmation of assent based on the indication obtained. Upon obtaining the confirmation, the payment gateway processes the purchase transaction based on the payment account information and returns a transaction result to the shopping customer device and to the paying customer device.

By providing, from a shopping customer device, a beacon signal which a paying customer device can receive and use to uniquely identify the transaction to the payment gateway, the present invention makes it possible for the paying customer to pay for a purchase on a different device. Thus, a customer may engage a better equipped device and/or a device with a better selection of accounts and/or better funded accounts, to pay for the purchase. Also, by separating the shopping and payment functions across different devices, the present invention makes it possible for payment to be made by either a same or a different customer than the customer who performs the shopping and selection of items. For example, a purchase may be paid for by a nearby spouse or parent of the shopping customer using an account maintained on the mobile device of the spouse or parent.

Still additional advantages may be realized in embodiments and/or circumstances where a purchase would not otherwise require the paying customer to directly interact with the paying customer device at the time of purchase. For example, while a paying customer's assent to pay or selection of a payment instrument might be accomplished by holding the device by hand in order to read a display and/or provide input to a touchscreen, this information might instead be obtained another way, such as by a vocal communication by the paying customer to the paying customer device or by a default presumption by the wallet application under predefined circumstances. In such a case, the invention provides the paying customer with the ability to pay for the purchase without having to retrieve the device from its specific location on or near the person of the paying customer. And where the paying customer's assent is presumed, the transaction may be performed without even having to locate the mobile device at all which may be, for example, in another part of a household in which the personal computer is located.

### BRIEF DESCRIPTION OF EXEMPLARY DRAWINGS

A more complete understanding of the present invention may be derived by referring to the detailed description and claims when considered in connection with the Figures, wherein like reference numbers refer to similar elements throughout the Figures.

FIG. 1 is a system diagram showing the main components of a version of a purchase transaction system in which a mobile device facilitates a purchase made with a personal computer;

FIG. 2 is a system diagram showing the main components of a version of a purchase transaction system in which a second mobile device facilitates a purchase made by a first mobile device;

FIG. 3 is a flowchart showing the main steps performed by a shopping customer system in accordance with an embodiment of the invention;

FIG. 4 is a flowchart showing the main steps performed by a paying customer device in accordance with an embodiment of the invention; and

FIG. 5 is a flowchart showing the main steps performed by a payment gateway in accordance with an embodiment of the invention.

It should be appreciated by one of ordinary skill in the art that, while the present invention is described with reference to the figures described above, the invention may include a variety of embodiments consistent with the description herein. It should also be understood that, where consistent with the description, there may be additional components not shown in the system diagrams or additional steps not shown in the flowcharts, and that such components and steps may be arranged or ordered in different ways.

### DETAILED DESCRIPTION OF EXEMPLARY EMBODIMENTS

A purchase transaction system is described below which facilitates a purchase transaction between a merchant and at least one customer. As used herein and where appropriate in the context of the description, the term “merchant” may refer to a business, a location or unit of such a business, a specific employee or agent of such a business, and so forth. A merchant, as used herein, may sell products and/or services on a retail and/or wholesale basis and may produce the products and/or services itself and/or acquire and resell them. Similarly, as used herein and appropriate to the context of the description, the term “customer” may refer to an individual who operates, possesses, interacts with and/or owns the customer device, an individual who communicates with the merchant and/or takes possession of the item or items, or an individual, group or entity who maintains a payment account from which funds are drawn to pay for the purchase.

Also as used herein, a “purchase”, “purchase transaction” or “transaction” may refer to, as appropriate, any financial transaction in which one party provides payment to another party, including a sale, lease, charitable contribution, tip, reimbursement, loan, repayment, settlement, judgment and so forth. In similar fashion, an “item” or “items” may refer to anything for which payment is provided, such as one or more products, services, donations, gratuities, rights, interests and so forth. The appropriate interpretation(s) of the terms “purchase”, “purchase transaction”, “merchant”, “customer”, “item”, “items” and other terms used herein will be comprehended by one of ordinary skill in the art in the context of their use in the description herein, and should be understood to potentially include all potential interpretations reasonably within the scope of the invention.

The purchase transaction system described herein employs “beacon” technology to advantageously facilitate a purchase transaction between a merchant and a customer using a mobile device equipped with such technology. As used herein, beacon technology refers to Bluetooth low energy (also known as Bluetooth LE, BLE, or Bluetooth Smart) technology, or technology based thereon. The term “beacon” as used herein may refer generally to beacon technology or may refer specifically to a device which uses beacon technology, such as a beacon transceiver that transmits a beacon signal to, and/or receives a beacon signal from, other devices that use beacon technology. An example of beacon technology is iBeacon™, provided by or associated with Apple, Inc. A beacon that uses iBeacon technology may be provided by Apple or by another company to be generally compatible with iBeacon technology, and may in some instances be referred to as an iBeacon. An example of an iBeacon-compatible beacon is the Estimote Beacon, which is provided by Estimote, Inc. and certified by Apple.

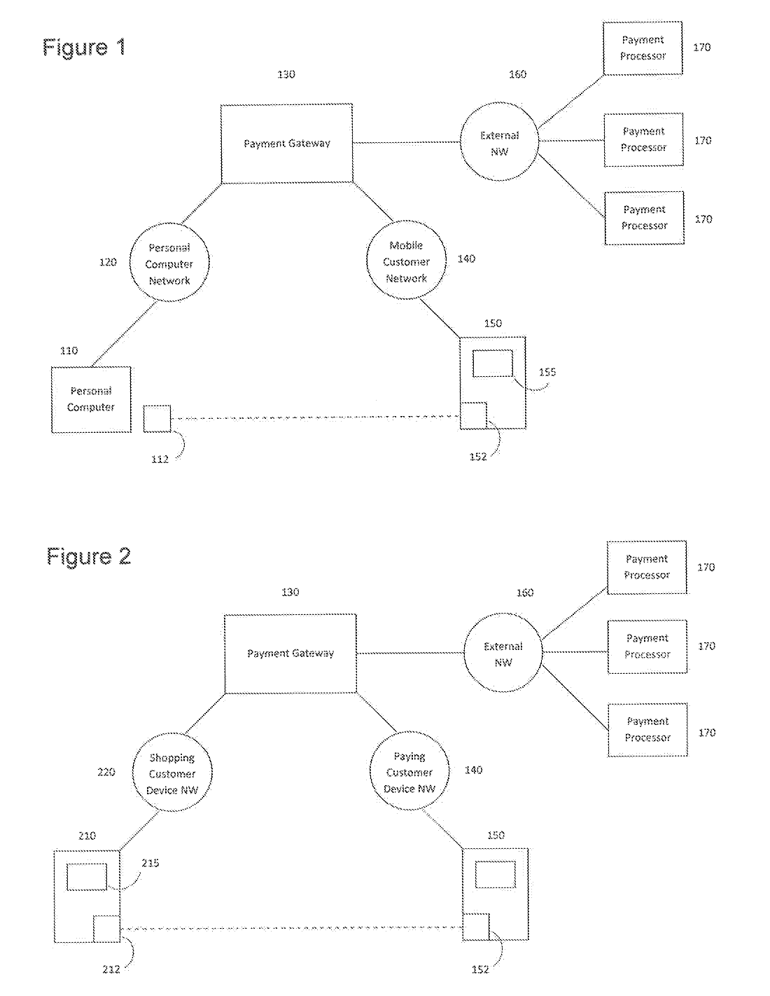

FIG. 1 shows an embodiment of a purchase transaction system in which a mobile customer device facilitates a purchase made with a personal computer. As shown, a personal computer 110 utilizes a personal computer beacon transceiver 112 to transmit beacon signals to other beacon equipped devices within a specified range. The personal computer 110 is, for example, a conventional desktop or laptop computer, additionally configured as appropriate to perform the functions described herein to facilitate a beacon-based transaction. The personal computer 110 includes a means for accessing an online merchant application such as via a conventional browser and/or client side software configured to operate in conjunction with server side software providing the online merchant application.

The personal computer beacon transceiver 112 is a beacon transceiver as described above, provided to operate in conjunction with the personal computer 110. The personal computer beacon transceiver 112 may be provided as part of the personal computer 110, attached or affixed to the personal computer 110, or separate from but proximate to the personal computer 110. The personal computer 110 communicates via a personal computer network 120 with a payment gateway 130. The personal computer network 120 is, for example, a conventional network capable of connecting the personal computer 110 to the payment gateway 130 over the Internet, and may include any external or local networks necessary to perform functions appropriate for the purpose of conveying information between the personal computer 110 and payment gateway 130. The payment gateway 130 contains means for handling payment transactions, wallet application server functions and so forth in an essentially conventional manner, but is additionally configured as appropriate to perform the functions described herein that facilitate beacon-based transactions.

The payment gateway 130 is also accessible via a mobile customer network 140 by a mobile customer device 150. The mobile customer network 140 includes, for example, an Internet connection between the mobile customer device 150 and the payment gateway 130, as may be facilitated by a cellular network and/or other means, and may include any external or local networks necessary to perform functions appropriate for the purpose of conveying information between the mobile customer device 150 and the payment gateway 130.

The mobile customer device 150 includes a mobile device beacon transceiver 152 and a wallet application 155. The mobile customer device 150 is, for example, a mobile communication device such as a Smartphone or other mobile computing device capable of being equipped with a beacon transceiver and a wallet application as described herein. One example of such a mobile customer device 150 would be an Apple iPhone running a version of the Apple iOS operating system and equipped with iBeacon. The mobile customer device 150 could also be a Google Android operating system based phone provided by any of a number of different makers such as Samsung, HTC, LG and Motorola and equipped with a beacon as described above.

The wallet application 155 is a software application at least partly resident on and executable by the mobile customer device 150 which allows the user to initiate and complete payments using previously stored or newly entered payment account information, and may contain additional capabilities such as the provision and management of receipts, coupons, discount offers, loyalty credits, and so forth. The wallet application 155 is, for example, a conventional wallet application that is additionally configured to facilitate beacon-based transactions as described herein.

The payment gateway 130 communicates via an external network 160 to any number of payment processors 170. Each payment processor 170 corresponds to an institution, or a component thereof, in which the customer may hold an account that can be accessed to make payments, and/or an institution in which the merchant may hold an account which is used to collect such payments. As used herein, a payment processor 170 may refer to a conventional credit card payment processor or payment network, a digital currency payment processor or any other entity appropriate for processing payments as described herein.

The present invention allows one device to be used to shop for and identify items to be purchased while a different device is used to pay for the purchase. As used herein, the term “shopping customer” may refer to a customer who shops for and identifies items to be purchased, and the term “paying customer” may refer to a customer who pays for the purchase. In different embodiments, the shopping customer and the paying customer may be a same customer or may be two different customers. The device operated by the paying customer may be referred to as a “paying customer device” and the device operated by the shopping customer may be referred to as a “shopping customer device.” In one embodiment, the shopping customer device may be a personal computer such as the personal computer 110 described above. In another embodiment, the shopping customer device may be a mobile device as described below.

FIG. 2 shows an embodiment of a purchase transaction system in which a second mobile device facilitates a purchase made by a first mobile device. As shown, a mobile shopping customer device 210 includes a mobile shopping customer device beacon transceiver 212. The mobile shopping customer device 210 is, for example, a mobile communication device such as a Smartphone. For example, mobile shopping customer device 210 could be an iBeacon-equipped iOS-based iPhone or could be a beacon-equipped Android-based phone provided by Samsung, HTC, LG or Motorola. Alternatively, where not equipped with a built-in beacon, the mobile shopping customer device 210 could be configured to operate with a mobile shopping customer device beacon transceiver 212 that is affixed to the mobile shopping customer device 210, or otherwise maintained in close proximity to the merchant mobile device. The mobile shopping customer device 210 communicates with the payment gateway 130 over a shopping customer device network 220 which includes, for example, an Internet connection between the mobile shopping customer device 210 and the payment gateway 130, as may be facilitated by a cellular network and/or other means, and may include any local networks as necessary to perform functions appropriate for the purpose of conveying information between the mobile shopping customer device 210 and the payment gateway 130.

The mobile shopping customer device 210 further includes a means for accessing an online merchant application which allows online purchases to be made via the mobile shopping customer device 210 similar to the function of the online merchant application of personal computer 110, but from a mobile device. The online merchant application may be accessed by a browser provided on the mobile shopping customer device 210 and/or client side software configured to operate in conjunction with server side software providing the online merchant application.

Other aspects of the financial transaction system are similar to those described above with reference to FIG. 1 and, as such, the other components are shown with the same reference numerals. It will be understood, however, that such components may operate differently at least as necessary to operate in conjunction with a mobile shopping customer device instead of a personal computer as was described with reference to FIG. 1. In such case, the mobile customer device 150 may be referred to as the mobile paying customer device and the mobile customer network 140 may be referred to as the mobile paying customer device network, such components being appropriately configured to interact with a mobile shopping customer device.

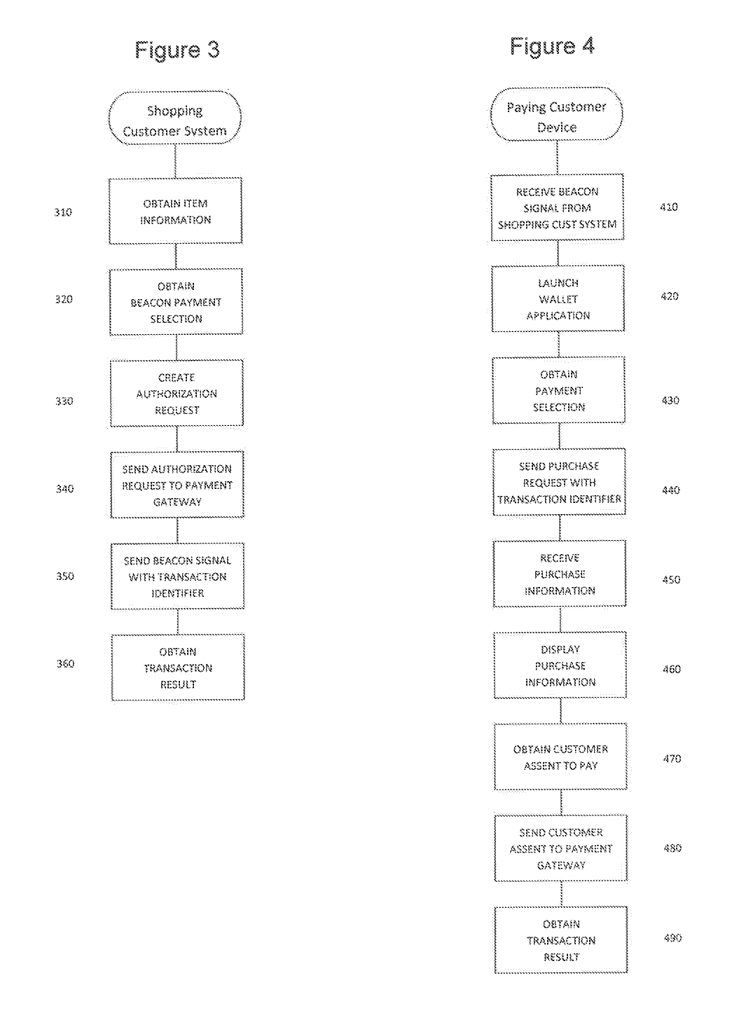

FIGS. 3 through 5 are flowcharts of the steps performed by components of the purchase transaction system, separated by the portion of the system (shopping customer system, paying customer device, payment gateway) that performs them. One of ordinary skill in the art will readily appreciate that, where appropriate and consistent with the general description herein, steps may be performed in a different order than shown and described.

FIG. 3 is a flowchart showing the main steps performed by a shopping customer system in accordance with an embodiment of the invention. The shopping customer system is implemented as some combination of a merchant system (not shown) running server side software of the online merchant application and a shopping customer device running client side software of the online merchant application and/or browser software that accesses the online merchant application. The shopping customer device is, for example, the combination of personal computer 110 and personal computer beacon transceiver 112 shown in FIG. 1 or is, for example, the mobile shopping customer device 210, including mobile shopping customer device beacon transceiver 212, shown in FIG. 2. The shopping customer system controls aspects of communication between the shopping customer device and the paying customer device as necessary to share information as described herein. In one possible embodiment, this may include a shopping customer wallet application installed on the shopping customer device 210 and configured to control aspects of communication with the wallet application 155 on the paying customer device based on information provided by and to the online merchant application.

In step 310, the shopping customer system obtains item information relating to one or more items identified to be purchased by the customer. This may be obtained, for example, by the shopping customer selecting items from a user interface provided by the online merchant application. The shopping customer system may be equipped with any number of security measures controlling user access to and interaction with the device, including password, personal identification number (PIN) or various biometric applications.

In step 320, the shopping customer system obtains from the shopping customer a beacon payment selection designating that a customer beacon will be utilized in performing the transaction and sends to the payment gateway a beacon payment indicator based on the beacon payment selection. As will be explained in more detail below, this effectuates an indication to the purchase transaction system that the present transaction will be a beacon based transaction. The beacon payment selection may be, for example, a selection by the shopping customer among options provided via a user interface provided by the online merchant application of the personal computer 110 or of the mobile shopping customer device 210. Alternatively, the beacon payment selection may be generated automatically upon receiving an acknowledgement from the paying customer device that a beacon signal sent by the shopping customer device (as is described below with reference to step 350) has been received by the paying customer device.

In step 330, the shopping customer system utilizes the item information and the beacon payment selection provided to create an authorization request which includes transaction information and a beacon payment indicator. The transaction information includes, for example, purchase amount, merchant identification number (MID) and so forth. The beacon payment indicator is, for example, a flag that indicates that the merchant beacon is utilized in performing the transaction, which informs the payment gateway to expect information provided therein to be received by the customer device and further provided to the payment gateway. The transaction information and the beacon payment indicator may be entered, for example, into designated and/or newly determined fields of an authorization request type ISO 8583 message, such fields to be recognized by the payment gateway as holding the transaction information and beacon payment indicator. In step 340, the shopping customer system sends the authorization request with the transaction information and the beacon payment indicator to the payment gateway.

In step 350, the shopping customer system sends a beacon signal containing a transaction identifier that uniquely identifies the present transaction, such that it will be received by the paying customer device. For example, the personal computer 110 invokes the personal computer beacon transceiver 112 to send the beacon signal, or the mobile shopping customer device 210 invokes the mobile shopping customer device beacon transceiver 212 to send the beacon signal such that it will be received by the mobile device beacon transceiver 152 of the mobile customer device 150.

As will be understood by one of ordinary skill in the art, a beacon is designed to send a concise collection of data in a format that will be recognized by the receiving device. An iBeacon compatible device, for example, has a 16 byte UUID field that contains a Universally Unique Identifier (UUID) value, a 2 byte Major field that holds a selectable major value, and a 2 byte Minor field that holds a selectable minor value. In such a configuration, the transaction identifier could be any value or set of values that is represented within one or a combination of these fields. The transaction identifier could be or could include, for example, a MID (in same or different format as above), a computer or device identification number, a purchase amount, virtual currency information, a Bitcoin invoice number, or any other information, or combination of such information, that is sufficient to uniquely identify the transaction.

The beacon signal described above and/or other beacon signals sent by the shopping customer device may also include additional information as appropriate, such as other transaction information, location information, a code or other indication of eligibility for a discount applicable to the present purchase or a potential future purchase, or any other application specific data useful in performing the transaction. Information provided within any such beacon signal may be contained within a single beacon signal or may be spread over multiple beacon signals.

In other embodiments, the shopping customer device may provide the transaction identifier by means other than a beacon signal. For example, the shopping customer device may provide the transaction identifier by displaying a machine readable optical label on a display screen of personal computer 110 which can then be read by the paying customer device. This label could be, for example, a matrix barcode such as a Quick Response (QR) code. In still other embodiments, the shopping customer device may provide the transaction identifier to the paying customer device via an Infrared (IR) signal, a short range wireless signal such as Wi-Fi or other proximate means of local short range communication. In such alternative embodiments, neither the shopping customer device nor the paying customer device would be required to be equipped with a beacon transceiver, but will be equipped and/or configured as appropriate to communicate the information described herein. For example, the mobile customer device 150 may be equipped with a software application that enables it to scan QR codes.

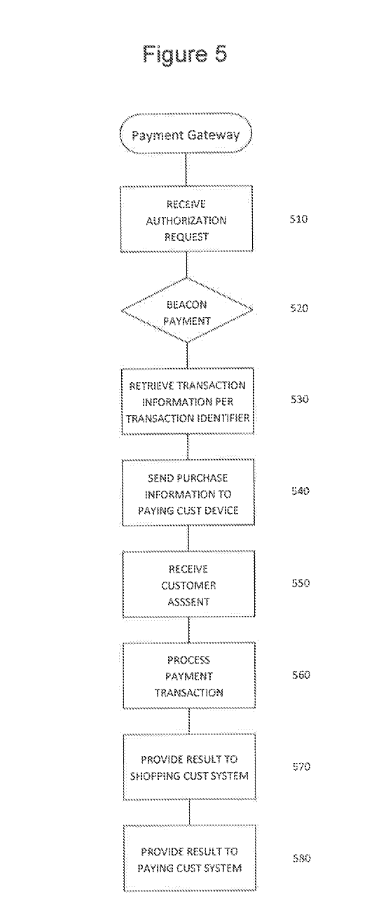

As performance of the transaction continues with actions performed by the payment gateway and the customer device, discussion will continue now with reference to FIGS. 4 and 5 before returning to FIG. 3. FIG. 4 is a flowchart showing the main steps performed by a paying customer device in accordance with an embodiment of the invention. The paying customer device is, for example, the mobile customer device 150.

In step 410, the paying customer device receives, from the shopping customer device, the beacon signal containing the transaction identifier that uniquely identifies the present transaction. For example, the mobile device beacon transceiver 152 of the mobile customer device 150 receives the beacon signal from either the personal computer beacon transceiver 112 (where the shopping customer device comprises personal computer 110) or the mobile shopping customer device beacon transceiver 212 (where the shopping customer device comprises mobile shopping customer device 210.)

The shopping customer device may be configured such that the beacon transceiver will transmit a beacon signal to devices only within a reasonably close proximity range so that the paying customer device will receive or acknowledge the signal due to the customer's proximity to the paying customer device. The shopping customer device may also be configured such that the beacon transceiver will transmit the beacon signal at a limited signal strength level that is selected taking into account not only distance but also the impact on accuracy of potential obstructions to the signal. In addition to this, the paying customer device may be configured to only acknowledge beacon signals from within a certain proximity range such that it will only receive or acknowledge beacon signals from a shopping customer device it is sufficiently close to at the time. The paying customer device may also be configured so as to recognize only beacon signals that surpass a designated level of signal strength that will take into account both distance and the impact on accuracy of potential obstructions to the signal.

In step 420, the paying customer device launches a wallet software application resident on the paying customer device. The wallet application may be launched by operation of the customer or it may be launched automatically by the paying customer device in response to the merchant beacon. For example, the mobile customer device 150 invokes the wallet application 155 upon the mobile device beacon transceiver 152 receiving a beacon signal from the personal computer beacon transceiver 112 (where the shopping customer device comprises personal computer 110) or from the mobile shopping customer device beacon transceiver 212 (where the shopping customer device comprises mobile shopping customer device 210.) In conjunction with the wallet application or otherwise, the paying customer device may be equipped with any number of security measures controlling user access to and interaction with the device, including password, personal identification number (PIN) or various biometric applications.

In step 430, the paying customer device obtains a payment type selection from the customer via the wallet application. For example, the wallet application may display a list of available payment options, each corresponding to a payment account maintained by the customer. These could include one or more credit card accounts, debit card accounts, checking accounts, or any other means of accessing funds that can be transferred to the merchant in payment for the purchase, potentially including digital currency, virtual currency, cryptocurrency and so forth. Examples include Visa, American Express, PayPal, Bitcoin, and so forth. In an alternative implementation, the wallet application may be configured so as to automatically select a payment option based on a default option previously designated by the customer, based on a determination made by the wallet application depending on a potential variety of factors such as available balances, user history and so forth.

In step 440, the paying customer device sends a purchase request to the payment gateway. For example, the mobile customer device 150 sends the purchase request to the payment gateway 130 via the mobile customer network 140. The purchase request includes payment information representing the payment account selected by the customer to pay for the purchase. The purchase request further includes the transaction identifier, received from the shopping customer device, which uniquely identifies the present transaction. It should be understood that the transaction identifier may be in a different form when provided by the customer device to the payment gateway than it was when sent by the shopping customer device to the paying customer device. The transaction identifier may be, for example, formatted or arranged differently and/or in a different form that is based on or derived from the form it was in when obtained from the shopping customer device, but such that it will still be ascertainable by the payment gateway to uniquely identify the present transaction. The transaction identifier may also be communicated to the payment gateway separately from the payment account information, such as separately from a purchase request that contains the account information, and thereafter be associated with the payment gateway in an appropriate fashion, such as being identified as part of a same communication or by cross reference or common reference.

In additional aspects of the invention, the paying customer device may send to the payment gateway additional information, whether provided together with the transaction identifier and/or together with or as part of the payment account information or separately and thereafter associated with such information by appropriate means. Such additional information may include a customer identifier that uniquely identifies the customer to the payment gateway, such as a customer wallet account number that corresponds to the customer's wallet account. The payment gateway may utilize the customer identifier to identify payment accounts of the customer and obtain corresponding payment account information stored by the payment gateway rather than the paying customer device, such that sensitive payment account information does not have to be transmitted by the customer device. Furthermore, such a customer identifier may be utilized by the payment gateway to determine whether the paying customer is entitled to any discounts as may be associated with membership in a loyalty program maintained by or otherwise associated with the merchant, and/or the customer's purchase history, behavioral history and so forth. In such case, the payment gateway may apply the discount to adjust the purchase amount before processing the payment, may communicate to the paying customer device that the discount was applied, and so forth.

FIG. 5 is a flowchart showing the main steps performed by the payment gateway in accordance with an embodiment of the invention. The payment gateway is, for example, the payment gateway 130 shown in FIGS. 1 and 2. It will be understood that the payment gateway may be protected by any number of security measures which prevent access to the system from outside parties including firewall protection and so forth, and which further control user access to and interaction with devices therein, including password, personal identification number (PIN) or various biometric applications.

In step 510, the payment gateway receives the authorization request provided by the shopping customer system in step 340. In step 520, the payment gateway determines whether the beacon payment indicator provided by the shopping customer device indicates that the merchant beacon is being utilized in performing the present purchase transaction. If not, the payment gateway handles the transaction by a different process (not shown) such as a conventional process for handling a transaction in which the customer's payment information would have been provided to the merchant, such as by presentation of a credit card or tapping of a phone to a reader, and then obtained by from the shopping customer device via the merchant network 120. If the payment gateway determines in step 520 that the beacon payment indicator indicates the merchant beacon is being utilized in performing the present purchase transaction, processing proceeds to steps 530 through 590 where the transaction will be handled accordingly.

In step 530, the payment gateway uses the transaction identifier obtained from the paying customer system to retrieve the transaction information supplied by the shopping customer device in the authorization request. It will be appreciated that this function may be performed in different ways depending on how the relevant information is represented, formatted, stored, accessed and retrieved in the implementation at hand. In step 540, the payment gateway sends purchase information based on the transaction information to the paying customer device. The purchase information may be the same as, or a portion of, the transaction information (or an authorization request containing the transaction information) or it may be derived from such transaction information or authorization request as appropriate to the implementation at hand. For example, the payment gateway 130 sends, via the mobile customer network 140, a purchase amount along with item information extracted from or determined based on the transaction information obtained in the authorization request.

Returning to FIG. 4, the paying customer device in step 450 receives the purchase information and, in step 460, displays the purchase information to the customer. For example, the mobile customer device 150 may display via the wallet application 155 a purchase amount along with relevant item information that identifies the item or items being purchased, allowing the customer to review the relevant information and ensure he or she wishes to complete the purchase. Additionally or alternatively, the paying customer device may provide the purchase information to the paying customer by other means, such as by an automated voice communication.

In step 470, the paying customer device obtains from the paying customer an indication of assent to pay for the item or items. This is obtained, for example, by displaying a purchase amount and obtaining a selection from the paying customer, such as by touching a touchscreen on the customer device, of a provided “OK to Pay” button or prompt via the wallet application 155. Additionally or alternatively, the paying customer device may obtain the selection from the customer by other means, such as by vocal communication from the paying customer to the device. In such a case, where appropriate and so configured, it becomes possible for the paying customer to pay for a purchase without having to physically retrieve the device. The paying customer device may be further configured to apply security measures to the selection, such as by performing a fingerprint scan when the user makes a selection through the touchscreen or by using voice recognition of a vocal selection or command to identify the customer. In step 480, the paying customer device sends to the payment gateway a confirmation of the paying customer's assent to pay based on the indication obtained from the customer.

In another embodiment of the invention, the wallet application may be configured to automatically assume the paying customer's assent to pay under certain circumstances, such as when the purchase amount does not surpass a predetermined threshold and/or is associated with a merchant and/or transaction type (as determined based on the purchase information and/or the transaction identifier and/or additional information maintained by the wallet application) that has been previously designated by the paying customer and/or determined by the wallet application to be trustworthy and/or require no customer assent for any other reasons. When combined with alternative variations such a described above wherein the wallet application is configured so as to automatically select a payment option based on a default option previously designated by the paying customer or otherwise, a transaction becomes possible which essentially requires no customer interaction beyond the initial selection(s) of the shopping customer.

Returning to FIG. 5, upon receiving the confirmation of customer assent from the paying customer device in step 550, the payment gateway processes the transaction in step 560. The payment gateway processes the transaction by providing at least a portion of the transaction information obtained from the online merchant system (or information based on such transaction information) and at least a portion of the payment information obtained from the paying customer (or information based on such payment information) to a payment processor corresponding to the payment account selected by the customer, and then receiving a result from the payment processor indicating whether the payment was successfully completed. It should be understood that the transaction information and payment information provided may be, as appropriate, formatted or arranged differently at different points in the transaction process, but will include or be derived from the data previously referenced by these terms.

As one example, the payment gateway 130 obtains a purchase amount from the authorization request and a payment account number from the purchase request and provides the information in appropriate form via the external network 160 to the payment processor 170 that corresponds to the owner of the payment account identified by the customer, and receives a response back from the payment processor 170 via the external network 160. If the transaction is successful (the customer payment account is valid, possesses sufficient funds, and so forth) the payment account of the paying customer is debited by the appropriate amount. Similarly, a financial account of the merchant is credited in the same amount by similar and/or conventional means.

The payment gateway then provides an indication of the result back to the shopping customer system in step 570 and to the paying customer device in step 580. Returning to FIG. 3, the shopping customer system obtains in step 360 the transaction result. If the transaction result indicates the payment was successfully processed, this confirms to the online merchant application that the transaction has been completed and the shopping customer can be informed via the shopping customer device, provided with an electronic receipt and so forth. If the transaction result indicates the payment was not successfully processed, this alerts the online merchant application that the purchase transaction is not complete, that alternative payment means may be required or may already be sought by the paying customer device or otherwise the transaction cannot be completed.

Similarly, returning to FIG. 4, the paying customer device obtains the transaction result in step 490 and, where the transaction result indicates the payment was successful, confirms that the transaction has been completed by, for example, providing to the paying customer an electronic receipt that the paying customer device can store and the paying customer may revisit at a later time via the wallet application. If the transaction result indicates the payment was not successfully processed, the paying customer device informs the paying customer and may obtain alternative means of payment on the instruction of the paying customer. For example, the wallet application 155 may notify the paying customer that another form of payment is required and obtain selection of that form of payment such that the payment gateway 130 will attempt to process the purchase transaction with a different payment account, and the remaining part of the process may be repeated in similar fashion.

In the foregoing specification, it should be appreciated that the particular implementations shown and described herein are illustrative of the invention and are not intended to otherwise limit the scope of the present invention in any way. Indeed, for the sake of brevity, conventional data networking, application development and other functional aspects of the systems (and components of the individual operating components of the systems) may not be described in detail herein. It should be noted that many alternative or additional functional relationships or physical connections might be present in a practical system.

The present invention may be described herein in terms of functional block components, optional selections and/or various processing steps. It should be appreciated that, unless otherwise stated or more specifically described herein, such functional blocks may be realized by any number of hardware and/or software components suitably configured to perform the specified functions. Furthermore, any databases, systems, devices, servers or other components of the present invention may consist of any combination thereof at a single location or at multiple locations, wherein each database or system includes any of various suitable security features, such as firewalls, access codes, encryption, decryption, compression, decompression, and/or the like.

Any system components discussed herein which involve the storage, access, reference, comparison, match or retrieval of data or similar functions, unless otherwise stated or more specifically defined, may be implemented with any appropriate system, including any type of database, such as relational, hierarchical, graphical, object-oriented, and/or other database configurations. Similarly, processing steps involving the performance of such functions may likewise be performed with any such appropriate system.

Unless otherwise stated or more specifically defined, the present invention may employ any number of conventional techniques for data transmission, messaging, data processing, network control, and/or the like. One skilled in the art will appreciate that, unless otherwise stated or more specifically described herein, a network may include any system for exchanging data or transacting business, such as the Internet, an intranet, an extranet, WAN, LAN, satellite communications, cellular network, and/or the like.

It should also be appreciated that any number of available security measures may be applied as appropriate to protect information at all stages of the purchase transaction including, but not limited to encryption, password or PIN number protection, speaker recognition and any biometric applications appropriate to secure and facilitate the functions described herein such as facial recognition, fingerprint detection, retinal scanning and so on.

The invention has been described with reference to specific embodiments. However, it may be appreciated that various modifications and changes may be made without departing from the scope of the present invention. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

What is claimed is:

1. A system for processing a purchase transaction, the system comprising:
means for obtaining, from a first mobile device operated by a shopping customer, transaction information related to the purchase transaction, the transaction information based on item information corresponding to an item selected by the shopping customer using an online merchant application accessed via the first mobile device;
means for obtaining, from a second mobile device operated by a paying customer, a transaction identifier extracted from a beacon signal transmitted by the first mobile device and payment account information corresponding to a customer payment account;
means for applying the transaction identifier to access the transaction information and generating purchase information based on the transaction information accessed;
means for sending, to the second mobile device, the purchase information for display to the customer to obtain an indication of assent to pay for the item;
means for obtaining, from the second mobile device, a confirmation of customer assent based on the indication obtained from the customer; and
means for processing, upon receiving the confirmation of customer assent from the second mobile device, the purchase transaction based on the payment account information.

2. The system of claim 1 wherein the paying customer operating the second mobile device is the shopping customer operating the first mobile device.

3. The system of claim 1 wherein the paying customer operating the second mobile device is different from the shopping customer operating the first mobile device.

4. A system for processing a purchase transaction, the system comprising:
means for obtaining, from a first mobile device operated by a shopping customer, transaction information related to the purchase transaction, the transaction information based on item information corresponding to an item selected by the shopping customer via using an online merchant application accessed via the first mobile device;
means for obtaining, from a second mobile device operated by a paying customer, a transaction identifier sent by the first mobile device and payment account information corresponding to a customer payment account;
means for applying the transaction identifier to access the transaction information and generating purchase information based on the transaction information accessed;
means for sending, to the second mobile device, the purchase information for display to the customer to obtain an indication of assent to pay for the item;
means for obtaining, from the second mobile device, a confirmation of customer assent based on the indication obtained from the customer; and
means for processing, upon receiving the confirmation of customer assent, the purchase transaction based on the payment account information.

5. The system of claim 4 wherein the paying customer operating the second mobile device is the shopping customer operating the first mobile device.

6. The system of claim 4 wherein the paying customer operating the second mobile device is different from the shopping customer operating the first mobile device.

7. The system of claim 4 wherein the means for obtaining the transaction identifier obtains the transaction identifier by reading a Quick Response code displayed by the first mobile device.

8. A paying mobile customer device for facilitating a purchase transaction, the paying mobile customer device operated by a paying customer and comprising:
a beacon transceiver for receiving a beacon signal containing a transaction identifier from a shopping mobile customer device, operated by a shopping customer, that obtains item information from the shopping customer via an online merchant application and sends transaction information based on the item information to a payment gateway;
means for sending payment account information and the transaction identifier to the payment gateway for application of the transaction identifier to access the transaction information received from the personal computer;
means for receiving, from the payment gateway, purchase information based on the transaction information accessed;
means for providing the purchase information to the customer;
means for obtaining an indication of assent to pay for the item; and
means for sending, to the payment gateway, a confirmation of customer assent based on the indication obtained from the customer, enabling the payment gateway to process the purchase transaction based on the payment account information.

9. The paying mobile customer device of claim 8 wherein the paying customer operating the mobile customer device is the shopping customer operating the shopping mobile customer device.

10. The paying mobile customer device of claim 8 wherein the paying customer operating the paying mobile customer device is different from the shopping customer operating the shopping mobile customer device.

11. A method for processing a purchase transaction, the method comprising the steps of:
obtaining, from a first mobile device operated by a shopping customer, transaction information related to the purchase transaction, the transaction information based on item information corresponding to an item selected by the shopping customer using an online merchant application accessed via the first mobile device;
obtaining, from a second mobile device operated by a paying customer, a transaction identifier extracted from a beacon signal transmitted by the first mobile device and payment account information corresponding to a customer payment account;
applying the transaction identifier to access the transaction information and generating purchase information based on the transaction information accessed;
sending, to the second mobile device, the purchase information for display to the customer to obtain an indication of assent to pay for the item;
obtaining, from the second mobile device, a confirmation of customer assent based on the indication obtained from the customer; and
processing, upon receiving the confirmation of customer assent from the second mobile device, the purchase transaction based on the payment account information.

12. The method of claim 11 wherein the paying customer operating the second mobile device is the shopping customer operating the first mobile device.

13. The method of claim 11 wherein the paying customer operating the second mobile device is different from the shopping customer operating the first mobile device.

14. A method for processing a purchase transaction, comprising the steps of:
obtaining, from a first mobile device operated by a shopping customer, transaction information related to the purchase transaction, the transaction information based on item information corresponding to an item selected by the shopping customer using an online merchant application accessed via the first mobile device;
obtaining, from a second mobile device operated by a paying customer, a transaction identifier sent by the first mobile device and payment account information corresponding to a customer payment account;
applying the transaction identifier to access the transaction information and generating purchase information based on the transaction information accessed;
sending, to the second mobile device, the purchase information for display to the customer to obtain an indication of assent to pay for the item;
obtaining, from the second mobile device, a confirmation of customer assent based on the indication obtained from the customer; and
processing, upon receiving the confirmation of customer assent from the second mobile device, the purchase transaction based on the payment account information.

15. The method of claim 14 wherein the paying customer operating the second mobile device is the shopping customer operating the first mobile device.

16. The method of claim 14 wherein the paying customer operating the second mobile device is different from the shopping customer operating the first mobile device.

17. The method of claim 14 wherein the step of obtaining the transaction identifier comprises obtaining the transaction identifier by reading a Quick Response code displayed by the first mobile device.

18. A method for facilitating a purchase transaction, the method performed by a paying mobile customer device operated by a paying customer and comprising the steps of:
receiving a beacon signal containing a transaction identifier from a shopping mobile customer device, operated by a shopping customer, that obtains item information from the shopping customer via an online merchant application and sends transaction information based on the item information to a payment gateway;
sending payment account information and the transaction identifier to the payment gateway for application of the transaction identifier to access the transaction information received from the shopping mobile customer device;
receiving, from the payment gateway, purchase information based on the transaction information accessed;
providing the purchase information to the customer;
obtaining an indication of assent to pay for the item; and
sending, to the payment gateway, a confirmation of customer assent based on the indication obtained from the customer, enabling the payment gateway to process the purchase transaction based on the payment account information.

19. The method of claim 8 wherein the paying customer operating the paying mobile customer device is the shopping customer operating the shopping mobile customer device.

20. The method of claim 8 wherein the paying customer operating the paying mobile customer device is different from the shopping customer operating the shopping mobile customer device.
